(19) United States
(12) Patent Application Publication
(10) Pub. No.: US 2003/0105691 A1
(43) Pub. Date: Jun. 5, 2003

(54) Method and apparatus for transferring wealth

(75) Inventors: Michael D. Brown, Irvine, CA (US); Jonathan G. Blattmachr, Garden City, NY (US)

Correspondence Address: Bernard L. Kleinke, Foley & Lardner, 23rd Floor, 402 West Broadway, San Diego, CA, 92101-3542, US

(73) Assignee: Spectrum Group Investments, LLC

(21) Appl. No.: 10/043,990

(22) Filed: Jan. 9, 2002

Related U.S. Application Data
(60) Provisional application No. 60/337,758, filed on Dec. 3, 2001.

(51) Int. Cl. G06F 17/60

(52) U.S. Cl. 705/35

(57) ABSTRACT

A system and method for the efficient transfer of wealth is disclosed. The method comprises gathering information on the amount of wealth to be transferred from a transferor to a transferee; determining the amount of life insurance premium for an insurance policy on the life of an insured individual to be substantially equal to the amount of the wealth to be transferred; and appraising a present value of a cash value of the insurance policy. The policy comprises a cash value and a term benefit. The transferee owns the term benefit, and an entity owns said cash value. The entity may be owned by the transferor. The appraising is based on a mortality risk of the insured individual and a value of the cash value during each year of a projected life of the insured individual, so that an appraised value of the cash value is obtained as a basis for a sale price of the cash value, whereby the wealth may be transferred to the transferee as the cash value.

### FIELD OF THE INVENTION

The present invention relates in general to a method and apparatus for transferring wealth. It more particularly relates to a method and apparatus for transferring wealth in an effective manner while reducing the tax consequences of the transaction.

### BACKGROUND ART

There have been many different types and kind of systems for implementing financial plans. For example, reference may be made to the following U.S. Pat. Nos. 3,634,669; 4,648,037; 5,191,522; 5,214,579; 5,231,571; 5,233,514; 5,429,506; 5,631,828; 5,761,441; 5,819,230; 5,933,815; 5,966,693; 5,999,917; 6,018,714; 6,064,969; 6,161,096.

Many of these financial plans relate to mortgages and insurance plans. However, they are not specifically related to the transfer of wealth from one person to another.

It has been found to be desirable to effectively transfer wealth to others, such as grandchildren or other family members in a cost-effective manner. There have been various estate planning techniques employed in the past. For example, generation-skipping trusts have been employed to be an effective tool in conveying one's wealth to members of one's family.

There can be undesirable costs incurred in connection with the funding of such a trust. Such costs can include the cost of liquidating assets at an undesirable time to fund the transfer. This is especially undesirable where very large sums of money or assets are to be transferred. Also, the funding of the trust can cause the unwanted imposition of taxes such as estate taxes or gift taxes which could otherwise diminish the effective amount of the funding. An outright transfer to another, such as a family member, can also, of course, trigger estate or gift taxes which would likewise diminish the amount of the transfer of wealth.

Thus, the disclosed embodiment of the present invention helps in the effective transfer of wealth, while minimizing or reducing the costs associated with the transfer.

### DESCRIPTION OF THE DRAWINGS

FIG. 1 is a diagrammatic view of a plan for transferring wealth according to one embodiment of the invention;

FIG. 2 is a block diagram of a system according to one embodiment of the invention for implementing and administering the wealth transfer plan illustrated in FIG. 1;

FIG. 3 illustrates a method according to an embodiment of the invention for implementing the plan for transferring wealth of FIG. 1 using the system of FIG. 2; and

FIG. 4 is a table illustrating one example of an appraisal calculation used by the system of FIG. 2 and the method of FIG. 3.

### DETAILED DESCRIPTION OF PREFERRED EMBODIMENTS

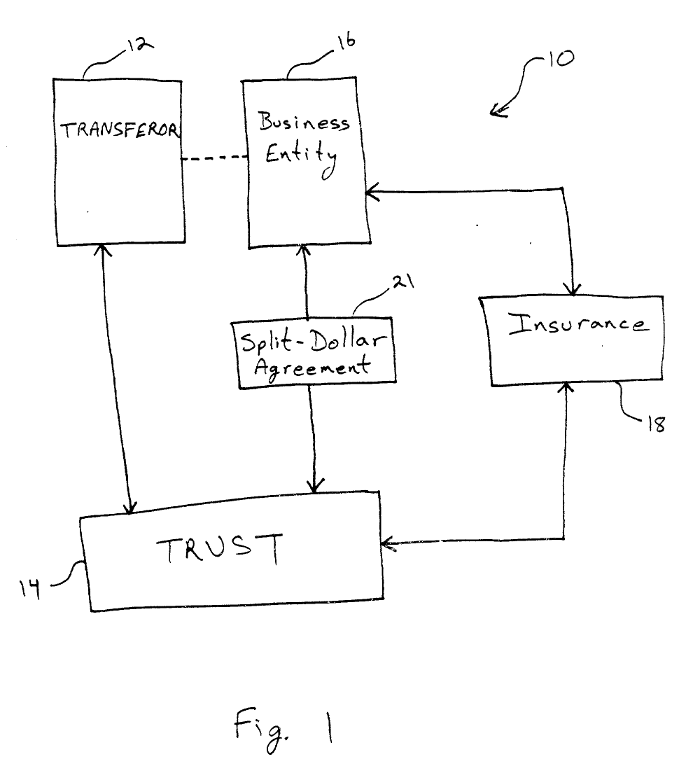

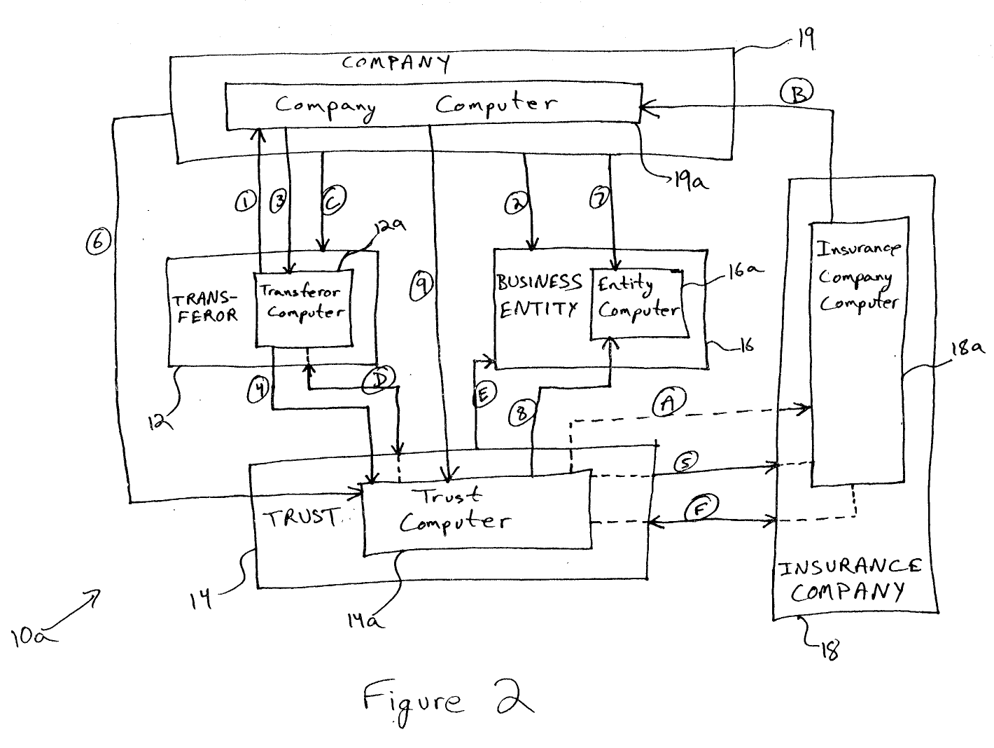

Referring now to the drawings, and more particularly to FIGS. 1-3 thereof, there is shown a plan 10 for transferring wealth in accordance with a preferred embodiment of the present invention. Further, FIG. 2 illustrates a system 10a according a preferred embodiment of the invention for implementing the plan illustrated in FIG. 1. Referring first to FIG. 1, the plan 10 includes a transferor 12 having a wealth to be transferred. The transferor 12 may be an individual or an entity such as a trust or a company subject to, for example, gift and estate taxes. Further, the transferor 12, as illustrated in FIG. 2, may comprise a transferor computer 12a, for example, of a financial institution having an account containing the wealth to be transferred.

Referring again to FIG. 1, a trust 14 may be provided to which the wealth is to be transferred. The trust 14 may have one or more beneficiaries such as, for example, children or grandchildren of the transferor 12. The trust 14 may be one of a variety of commonly used trusts. As illustrated in FIG. 2, the trust 14 may include a trust computer 14a for communicating with and transferring funds from and to other entities.

Referring again to FIG. 1, the plan 10 also comprises a business entity 16. The business entity 16 is initially owned by the transferor 12. The transferor 12 may either create the business entity 16 or purchase it from another source. The business entity 16 may be one of many common forms such as a corporation or a limited liability company. As illustrated in FIG. 2, the business entity 16 may include an entity computer 16a.

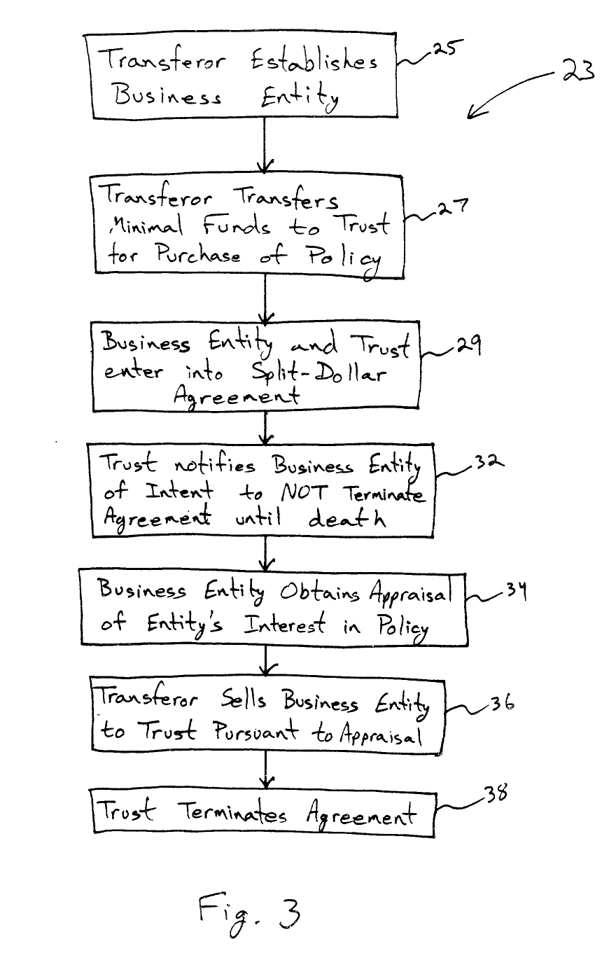

Referring again to FIG. 1, the plan 10 further includes the use of an insurance policy issued by, for example, an insurance company 18. The insurance policy may be a life insurance policy with a term component and a cash value component. Further details of the insurance policy are provided below with reference to FIG. 3. As illustrated in FIG. 2, the insurance company 18 also includes an insurance company computer capable of communicating and transferring funds with other entities.

Referring again to FIG. 1, ownership, responsibilities and benefits of the insurance policy are governed by a split-dollar agreement 21 entered into by the business entity 16 and the trust 14. The split-dollar agreement 21 divides the benefits of the insurance policy by assigning the term benefits to one party and the cash value to the other party.

The implementation of the wealth transfer plan illustrated in FIG. 1 may be accomplished according to the system 10a illustrated in FIG. 2 and the method 23 illustrated in FIG. 3. The plan is initiated by the transferor by providing sufficient financial information to a plan administration company 19 having a company computer 19a, as illustrated by line 1 in FIG. 2, where the information may be transferred from the transferor computer 12a, such as by electronic mail, to the company computer 19a. The company 19 may then establish a business entity 16 such as a corporation or a limited liability company (line 2 of FIG. 2, block 25 of FIG. 3).

The entity 16 may be established directly by the company 19 or by another incorporating entity. The transferor 12 may be an individual intending to transfer wealth to his heirs or a corporation seeking to bestow a tax benefit upon an employee by reducing the tax liability. The business entity 16 may be created for the sole purpose of accomplishing the wealth transfer. Alternatively, the wealth transfer may be only a portion of the purpose of the business entity 16.

At block 27 of FIG. 3, the company 19 causes the transferor 12 to transfer a minimal or initial amount of funds to the trust 14. This is illustrated in FIG. 2 by lines 3 and 4. In this regard, the company computer 19a sends a message to the transferor computer 12a directing the transferor 12 to make the transfer. In response thereto, at line 4, the funds are transferred to the trust 14 and recorded in the trust computer 14a.

As noted above, the beneficiaries of the trust 14 are the intended recipients of the transferred wealth. In one embodiment, the beneficiaries are the heirs of an individual. In another embodiment, the beneficiary is a selected employee of the transferor employer. This initial transfer of funds may be taxable either as a gift or as an estate transfer and, therefore, is preferably limited to a minimal or small amount. In another embodiment, this transfer of funds is in the form of a loan for which the trust 14 transfers a note to the transferor 12. With this initial transfer amount, the trust 14 purchases a life insurance policy from the insurance company 18, as illustrated by line in FIG. 2. Thus, the trust 14 is the owner of the policy.

At block 29 of FIG. 3, the company 19 causes the business entity 16 and the trust 14 to enter into a split-dollar agreement. In FIG. 2, this is illustrated by lines 6 and 7. As indicated at lines 6 and 7, instruction messages are sent from the company computer 19a to the respective computers 14a and 16a, whereby the trust 14 and the business entity 16 enter into a split-dollar agreement.

The split-dollar agreement is a collateral split-dollar agreement which assigns the death benefit of the policy to the trust 14 and collaterally assigns the cash value to the business entity 16 in exchange for the payment of the premiums for the policy. The trust 14, as the owner of the death benefit, may pay the share of the premium attributable to the annual term cost. Alternatively, that amount may be allocated as a taxable transfer from the business entity 16 to the trust 14.

All future premiums for the policy may be paid directly by the business entity 16 to the insurance company 18. Preferably, the business entity 16 pays a significant premium into the policy. The amount of the premium may be limited by tax laws, resulting in a maximum premium without negative tax consequences.

The split-dollar agreement entitles the business entity 16 to receive the cash value at either the termination of the split-dollar agreement or the death of the insured. The agreement may be adapted to be terminated at the will of the insured.

At block 32 of FIG. 3, the trust 14 notifies the business entity 16 of its intention to not terminate the split-dollar agreement until the death of the insured. In FIG. 2, this notification is illustrated by line 8, where the notification message may be sent from the trust comptuer 14a to the entity computer 16a. Using this notification as a basis, the business entity 16, at block 34 of FIG. 3, initiates an appraisal of the business entity's interest in the policy. The initiation of the appraisal is illustrated in FIG. 2 by line 9, where the company computer 19a sends an instruction message to the trust computer 14a, which in turn sends a request message at line A to the insurance company computer 18a to request an appraisal.

Preferably, this appraisal is initiated after all of the premium payments for the life of the policy have been made. For example, three years of premium payments may be sufficient to secure the policy for the life of the insured.

A professional appraiser may be engaged by the insurance company 18 as indicated at line A or directly by the trust 14, where an independent appraisal may be preferred, to perform this function. Since the business entity 16 may not obtain access to the cash value until the death of the insured, the appraisal represents the present value of the presently inaccessible cash value of the policy.

Once the appraisal is obtained, it is sent to the company computer 19a, for example, from the insurance company computer 18a via line B. The present value of the cash value may then be calculated by the company computer 19a, for example, by assigning a mortality risk to each year of the life of the insured. For example, a 40-year-old male may have a 0.203% probability of dying in the first year, a 0.217% in the second year, etc. For each year, the mortality risk may be multiplied by the cash value of the policy in that year to obtain an annual value for the interest. The present value of the annual value of the interest may then be obtained for each year by discounting the present value by an applicable rate such as an applicable federal rate (AFR). The present values for each year may then be summed by the company computer 19a to obtain the total present value of the inaccessible cash value of the policy.

Appraisals may be provided and stored in the company computer 19a using current mortality and earning assumptions. This appraisal may generally reflect the amount paid into the policy by the business entity. However, additional appraisals may be obtained using guaranteed mortality costs and interest rates. This calculation generally results in a much lower present value of the interest (approximately 10 percent the value obtained using current assumptions). An additional appraisal may be obtained using a mid-point calculation that is presumably more realistic. This calculation typically results in a present value of the interest that is approximately 20 percent the value obtained using current assumptions. Further, lower appraisals may be obtained by using a discount rate other than the AFR. For example, a market rate such as the prime rate may be used.

At block 36 of FIG. 3, the company 19 causes the transferor 12 to sell the business entity 16 to the trust 14 pursuant to the appraisal of the cash value of the policy. This sale is represented in FIG. 2 by lines C and D, where line C indicates an instruction message being sent from the company computer 19a to the transferor computer 12a. In response thereto, a message is sent from the transferor computer 12a to the trust computer 14a, thereby instructing the trust 14 to sell the business entity 16 to the trust 14. By using the lower, but valid, appraisals, the sale price of the business entity 16 is significantly reduced. The trust 14 may pay for the business entity 16 using existing funds or, alternatively, may provide a note to the transferor 12 in exchange for the business entity 16.

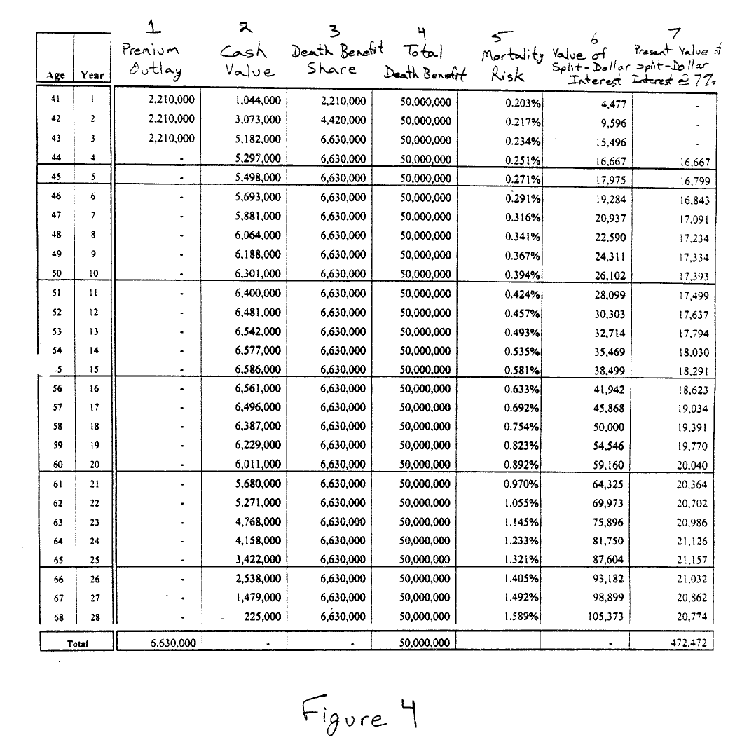

Once the business entity 16 has been transferred to the trust 14, the trust 14 owns both the death benefit and the cash value of the insurance policy, rendering the split-dollar agreement meaningless. Thus, at block 38 of FIG. 3, the company 19 may cause the trust 14 to terminate the agreement, as illustrated in FIG. 2 by line E. At termination, the insurance company 18 distributes the cash value of the policy to the trust 14, as indicated by line F in FIG. 2, where the funds are transferred to the trust 14, and the amount of the funds is stored in the trust computer 14a. If the trust 14 had given a note to the transferor 12 for the sale of the business entity 16, that note may be paid off using the distribution. The distributed value is indicative of the premiums paid by the business entity 16 to the insurance company and may be substantially greater than the appraised value of the cash value interest. For example, FIG. 4 illustrates the appraisal calculation using guaranteed mortality costs and interest rates for a 40-year-old male. As noted at the end of column 7 of the table, the appraised value is approximately $470,000, while the cash value at year 5 is nearly $5,500,000. Thus, more than $5 million may be transferred without gift or estate taxes.

The sale of the business entity 16 and the termination of the split-dollar agreement may be performed at anytime after the payment of the premiums.

It is to be understood that while various communications taking place between various computers may be conveniently accomplished via electronic mail, other forms of communication may also be employed, such as, for example, postal mail, telephone or other forms of communication. Also, the appraisal calculations, such as the present value calculations, may be accomplished by the insurance company computer 18a, the company computer 19a, or by any other computer

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

What is claimed is:

1. A method of transferring wealth, comprising:
causing a transferee to purchase an insurance policy from an insurance seller on the life of an insured individual, said policy comprising a cash value and a term benefit;
dividing ownership of said policy between said transferee and an entity owned by a transferor, wherein said transferee owns said term benefit and said entity owns said cash value in said divided ownership;
causing said entity to transfer wealth as premiums for said insurance policy to said insurance seller;
appraising a present value of said cash value, said appraising being based on a mortality risk of said insured individual and a value of said cash value during each year of a projected life of said insured individual; and
causing said cash value to be sold to said transferee, a sale price being based on said appraising.

2. The method according to claim 1, further comprising:
causing said transferee to notify said entity of an intention to maintain said divided ownership until death of said insured individual.

3. The method according to claim 1, further comprising:
causing said transferee to terminate said policy after sale of said cash value, thereby transferring a cash value to said transferee.

4. The method according to claim 1, wherein said transferee is a trust.

5. The method according to claim 1, wherein said entity is a corporation.

6. The method according to claim 1, wherein said entity is a limited liability company.

7. A system of transferring wealth, comprising:
means for causing a transferee to purchase an insurance policy from an insurance seller on the life of an insured individual, said policy comprising a cash value and a term benefit;
means for dividing ownership of said policy between said transferee and an entity owned by a transferor, wherein said transferee owns said term benefit and said entity owns said cash value in said divided ownership;
means for causing said entity to transfer wealth as premiums for said insurance policy to said insurance seller;
means for appraising a present value of said cash value, said appraising being based on a mortality risk of said insured individual and a value of said cash value during each year of a projected life of said insured individual; and
means for causing said cash value to be sold to said transferee, a sale price being based on said appraising.

8. The system according to claim 7, further comprising:
means for causing said transferee to notify said entity of an intention to maintain said divided ownership until death of said insured individual.

9. The system according to claim 7, further comprising:
means for causing said transferee to terminate said policy after sale of said cash value, thereby transferring a cash value to said transferee.

10. The system according to claim 7, wherein said transferee is a trust.

11. The system according to claim 7, wherein said entity is a corporation.

12. The system according to claim 7, wherein said entity is a limited liability company.

13. A program product, comprising machine readable program code for causing a machine to perform the following method steps:
causing a transferee to purchase an insurance policy from an insurance seller on the life of an insured individual, said policy comprising a cash value and a term benefit;
dividing ownership of said policy between said transferee and an entity owned by a transferor, wherein said transferee owns said term benefit and said entity owns said cash value in said divided ownership;
causing said entity to transfer wealth as premiums for said insurance policy to said insurance seller;
appraising a present value of said cash value, said appraising being based on a mortality risk of said insured individual and a value of said cash value during each year of a projected life of said insured individual; and
causing said cash value to be sold to said transferee, a sale price being based on said appraising.

14. A method of transferring wealth, comprising:
gathering information on the amount of wealth to be transferred;
determining the amount of life insurance premium for an insurance policy on the life of an insured individual to be substantially equal to the amount of the wealth to be transferred;
appraising a present value of a cash value of the insurance policy, said policy comprising a cash value and a term benefit, where a transferee owns said term benefit and an entity owns said cash value, said entity being owned by a transferor;
said appraising being based on a mortality risk of said insured individual and a value of said cash value during each year of a projected life of said insured individual so that an appraised value of said cash value is obtained as a basis for a sale price of said cash value, whereby said wealth may be transferred to said transferee as said cash value.

15. A system of transferring wealth, comprising:
means for gathering information on the amount of wealth to be transferred;
means for determining the amount of life insurance premium for an insurance policy on the life of an insured individual to be substantially equal to the amount of the wealth to be transferred;
means for appraising a present value of a cash value of the insurance policy, said policy comprising a cash value and a term benefit, where a transferee owns said term benefit and an entity owns said cash value, said entity being owned by a transferor;
said means for appraising basing an appraisal on a mortality risk of said insured individual and a value of said cash value during each year of a projected life of said insured individual so that an appraised value of said cash value is obtained as a basis for a sale price of said cash value, whereby said wealth may be transferred to said transferee as said cash value.

16. A system of transferring wealth, comprising:
an information gathering computer adapted to gather information on the amount of wealth to be transferred;
a premium determining computer adapted to determine the amount of life insurance premium for an insurance policy on the life of an insured individual to be substantially equal to the amount of the wealth to be transferred;
an appraisal computer adapted to appraise a present value of a cash value of the insurance policy, said policy comprising a cash value and a term benefit, where a transferee owns said term benefit and an entity owns said cash value, said entity being owned by a transferor;
said appraisal computer adapted to base an appraisal on a mortality risk of said insured individual and a value of said cash value during each year of a projected life of said insured individual so that an appraised value of said cash value is obtained as a basis for a sale price of said cash value, whereby said wealth may be transferred to said transferee as said cash value.
